(19) United States
(12) Patent Application Publication
(10) Pub. No.: US 2023/0153350 A1
(43) Pub. Date: May 18, 2023

(54) MUSIC RECOMMENDATION SYSTEM BY FACIAL EMOTION USING DEEP LEARNING

(71) Applicants: Nima Jafari Navimipour, Istanbul (TR); Seyed-Sajad Ahmadpour, Istanbul (TR); Bandan Kumar Bhoi, Burla (IN); Mohan Chandra Pradhan, Telangana (IN); Ratiranjan Senapati, Bangalore (IN); L.K. Abhilashi, Mandi (IN); Parinidhi Singh, Navi Mumbai (IN); Reena Singh, Pune (IN); Pawan Kumar Singh, Navi Mumbai (IN); B.K. Sarkar, Pune (IN)

(72) Inventors: Nima Jafari Navimipour, Istanbul (TR); Seyed-Sajad Ahmadpour, Istanbul (TR); Bandan Kumar Bhoi, Burla (IN); Mohan Chandra Pradhan, Telangana (IN); Ratiranjan Senapati, Bangalore (IN); L.K. Abhilashi, Mandi (IN); Parinidhi Singh, Navi Mumbai (IN); Reena Singh, Pune (IN); Pawan Kumar Singh, Navi Mumbai (IN); B.K. Sarkar, Pune (IN)

(21) Appl. No.: 18/157,419

(22) Filed: Jan. 20, 2023

(51) Int. Cl. G06F 16/635; G10L 25/63; G10L 25/30; G10L 21/0272; G10H 1/00; G06F 16/65

(52) U.S. Cl. CPC G06F 16/636; G10L 25/63; G10L 25/30; G10L 21/0272; G10H 1/0008; G06F 16/65; G10H 2210/031; G10H 2250/311

(57) ABSTRACT

The system comprises an input device for collecting sound and sound information or extracting sound information from a music sample; a pre-processor for pre-processing the informational collection to generate an input information test set for a characterization model, wherein the pre-processor utilizes fine-grained division and different techniques to preprocess the example informational collection; a central processor for combining sound feeling data and further developing arrangement speed, such that review makes fine-grained division for genuine music informational collection and results the inclination results by casting a ballot direction, which is configured to promote precision of music feeling grouping; a vocal division device for dividing vocal of the complicated structure of genuine music sound, and voice and foundation sound are incorporated together; and a reviewing device for reviewing the vocal detachment of music and reviewing the grouping impact of vocal and foundation sound individually, which incredibly builds the convergence of sound elements.

### FIELD OF THE INVENTION

The present disclosure relates to a music recommendation system by facial emotion using deep learning. In more detail, the system provides the unequivocal meagre consideration instrument to screen out a couple of data intentionally, which makes the consideration dispersion more engaged.

### BACKGROUND OF THE INVENTION

Music feeling acknowledgment is a significant part of music data recovery, and it is additionally the most difficult examination heading. In the field of full of feeling registering, music feeling acknowledgment is another issue.

From one perspective, music feeling acknowledgment is impacted areas of strength for by factors; then again, the portrayal of music feeling requires the plan of intricate music highlights. 'Erefore, the programmed acknowledgment of music feeling has not been actually and broadly utilized in day-to-day existence, and it is still in its earliest stages. 'Ere are numerous inadequacies that should be gotten to the next level.

In the conventional tune feeling characterization, the normally utilized technique is manual checking, however from the hour of coordinating people and the intricacy of work circulation, the manual stamping strategy has become over the top expensive, which can't stamp the melody feeling classification with a lot of information and can't meet the necessities of different fields and clients to recover music data.

In the view of the forgoing discussion, it is clearly portrayed that there is a need to have a music recommendation system by facial emotion using deep learning.

### SUMMARY OF THE INVENTION

The present disclosure seeks to provide a system for music recommendation by facial emotion using deep learning and sound division. Sound informational collection utilized in customary sound feeling arrangement research is unadulterated music fragment or voice section. Its sound span is short and its organization is somewhat single, which is very unique in relation to genuine music. Current music is put away as advanced music. Length of popular music sound is normally 3-4 minutes, including instruments, effectors, vocals, etc. The genuine popular music is utilized as the wellspring of the informational index. During the time spent highlight extraction, there are issues that the music time is excessively lengthy, bringing about too enormous element aspects and complex parts. To take care of the above issues, two sound division preprocessing strategies are proposed. Fine-Grained Division. Too prolonged stretch of time will prompt too enormous element aspect, slow preparation speed, and the classifier being inclined to overfitting. To combine the sound feeling data and further develop the arrangement speed, this review makes fine-grained division for the genuine music informational collection and results the inclination results by casting a ballot direction, which can really work on the precision of music feeling grouping. Vocal Division. structure of genuine music sound is complicated, and the voice and foundation sound are incorporated together. In the customary examination on unadulterated music cuts, the exhibition of sound element grouping is exceptional. The review preprocesses the vocal detachment of music and review the grouping impact of vocal and foundation sound individually, which incredibly builds the convergence of sound elements.

In an embodiment, a music recommendation system by facial emotion using deep learning is disclosed. The system includes an input device for collecting sound and sound information or extracting sound information from a music sample.

The system further includes a pre-processor for pre-processing the informational collection to generate an input information test set for a characterization model, wherein the pre-processor utilizes fine-grained division and different techniques to preprocess the example informational collection.

The system further includes a central processor for combining the sound feeling data and further developing the arrangement speed, such that review makes fine-grained division for the genuine music informational collection and results the inclination results by casting a ballot direction, which is configured to promote precision of music feeling grouping.

The system further includes a vocal division device for dividing vocal of the complicated structure of genuine music sound, and the voice and foundation sound are incorporated together.

The system further includes a reviewing device for reviewing the vocal detachment of music and reviewing the grouping impact of vocal and foundation sound individually, which incredibly builds the convergence of sound elements, wherein the unequivocal scanty consideration network is brought into the profound learning organization to diminish the impact of insignificant data on the acknowledgment results and further develop the feeling characterization and acknowledgment capacity of music test informational collection.

An object of the present disclosure is to utilize fine-grained division and different techniques to preprocess the example informational collection.

Another object of the present disclosure is to provide a decent capacity of music feeling acknowledgment and characterization.

Yet another object of the present invention is to deliver an expeditious and cost-effective system for music recommendation by facial emotion.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of a music recommendation system by facial emotion using deep learning in accordance with an embodiment of the present disclosure;

FIG. 2 illustrates a music recommendation by facial emotion using deep learning flow in accordance with an embodiment of the present disclosure;

FIG. 3 illustrates a music recommendation by facial emotion using deep learning method in accordance with an embodiment of the present disclosure; and

FIG. 4 illustrates a music recommendation by facial emotion using deep learning complete status in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

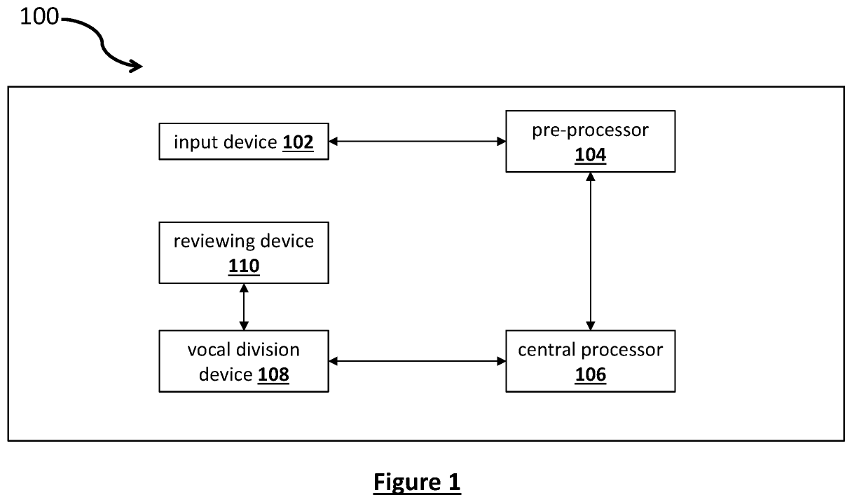

Referring to FIG. 1, a block diagram of a music recommendation system by facial emotion using deep learning is illustrated in accordance with an embodiment of the present disclosure. The system 100 includes an input device 102 for collecting sound and sound information or extracting sound information from a music sample.

In an embodiment, a pre-processor 104 is connected to the input device 102 for pre-processing the informational collection to generate an input information test set for a characterization model, wherein the pre-processor 104 utilizes fine-grained division and different techniques to preprocess the example informational collection.

In an embodiment, a central processor 106 is connected to the pre-processor 104 for combining the sound feeling data and further developing the arrangement speed, such that review makes fine-grained division for the genuine music informational collection and results the inclination results by casting a ballot direction, which is configured to promote precision of music feeling grouping.

In an embodiment, a vocal division device 108 is connected to the central processor 106 for dividing vocal of the complicated structure of genuine music sound, and the voice and foundation sound are incorporated together.

In an embodiment, a reviewing device 110 is connected to the vocal division device 108 for reviewing the vocal detachment of music and reviewing the grouping impact of vocal and foundation sound individually, which incredibly builds the convergence of sound elements, wherein the unequivocal scanty consideration network is brought into the profound learning organization to diminish the impact of insignificant data on the acknowledgment results and further develop the feeling characterization and acknowledgment capacity of music test informational collection.

In another embodiment, the Fine-Grained Division is configured to optimize the pre-processor to resolve the issues selected from too prolonged stretch of time prompts too enormous element aspect, slow preparation speed, and the classifier being inclined to overfitting.

In another embodiment, the fine-grained division and different techniques are employed to optimize the time spent highlight extraction even if the music time is excessively lengthy, bringing about too enormous element aspects and complex parts.

In another embodiment, the current music is put away as advanced music, wherein the genuine popular music is utilized as the wellspring of the informational index.

In another embodiment, the recreation try depends on the genuine informational index of the organization.

In another embodiment, the part of component extraction and component determination through the convolution layer and pooling layer in the CNN model, wherein the CNN model results a bunch of serialized highlight vectors, inputs them into the LSTM network as new elements, and adds an unequivocal scanty consideration network for yield.

In another embodiment, the feeling characterization is selected from calm, happy, sad, energetic and the like.

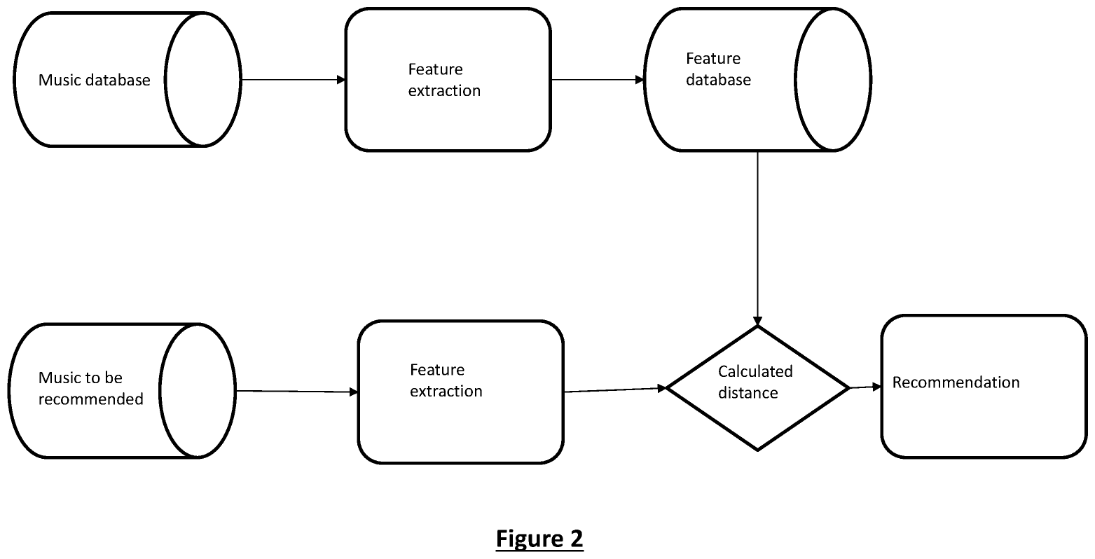

FIG. 2 illustrates a music recommendation by facial emotion using deep learning flow in accordance with an embodiment of the present disclosure.

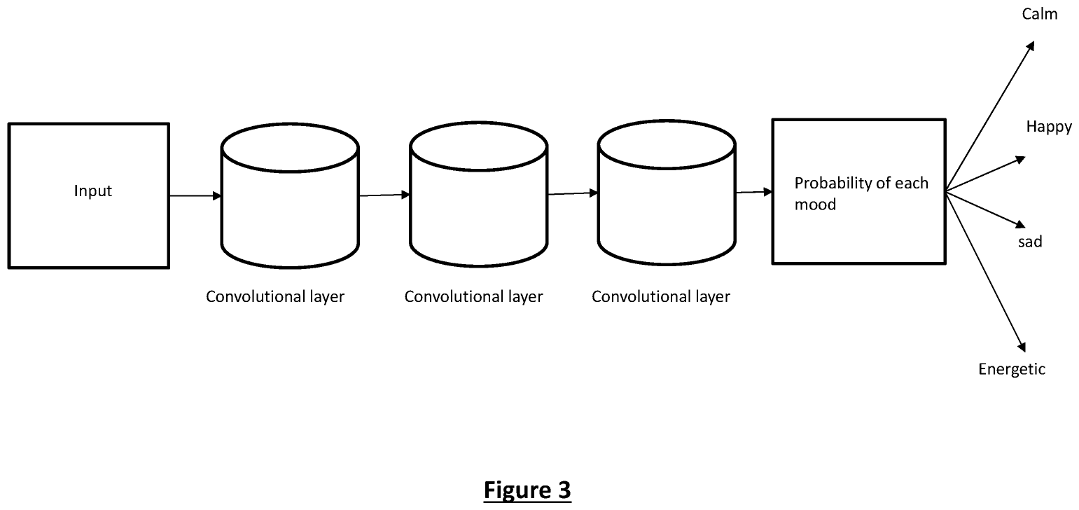

FIG. 3 illustrates a music recommendation by facial emotion using deep learning method in accordance with an embodiment of the present disclosure.

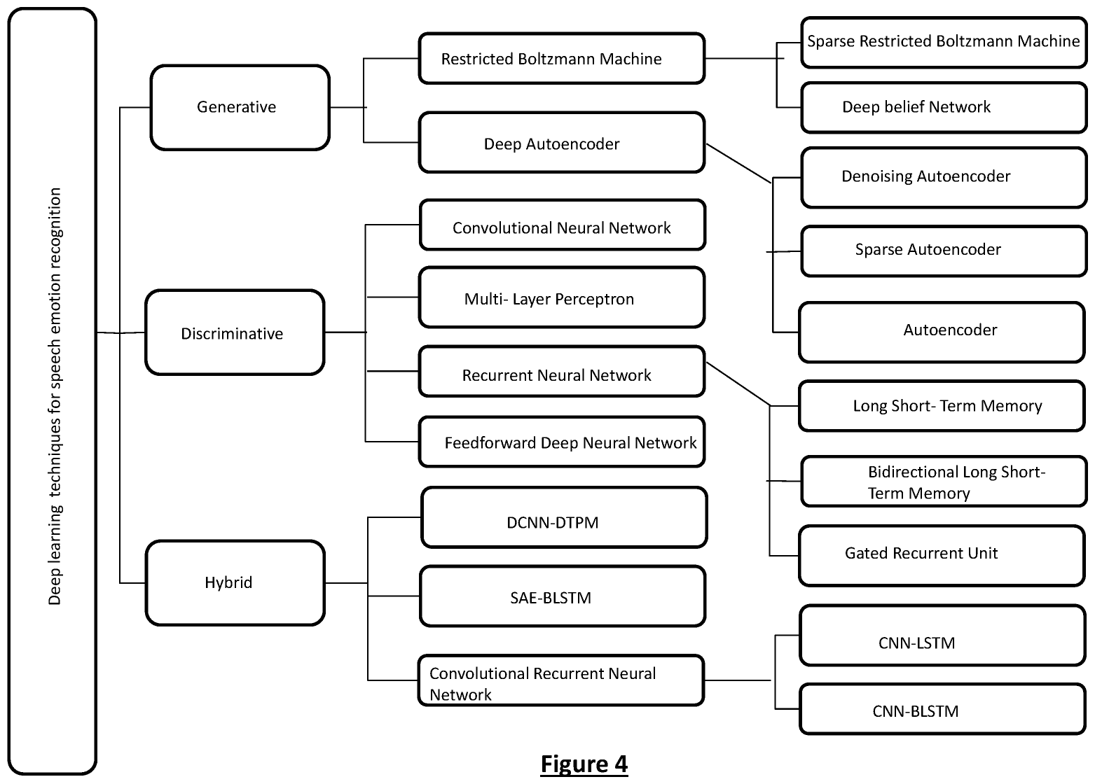

FIG. 4 illustrates a music recommendation by facial emotion using deep learning complete status in accordance with an embodiment of the present disclosure.

Model Development. In view of the subject of music feeling grouping, sound feeling order frequently needs to coordinate range elements and timing highlights simultaneously.

Because of the presence of convolution pooling structure, the convolution brain network major areas of strength for has combination and element extraction capacity for two-dimensional information, and it can additionally pack highlights.

A repetitive brain network can deal with serialized include information. 'Erefore, develops a combination feeling grouping model in view of CNN-LSTM to characterize and yield feeling highlight information. Combination order model in light of CNN-LSTM takes the sound highlights as the organization input, in which the spectrogram highlights assume.

The part of component extraction and component determination through the convolution layer and pooling layer in the CNN. Model results a bunch of serialized highlight vectors, inputs them into the LSTM network as new elements, and adds an unequivocal scanty consideration network for yield.

Music contains rich human close to home data. Investigation of music profound grouping is useful to coordinate huge music information. The study brings the profound organization model into the express scanty consideration component for enhancement, further develops the element data obtaining capacity of the feeling acknowledgment model.

The system “Music Recommendation by Facial Emotion using deep learning” is a work on the precision of music feeling acknowledgment and arrangement, this review consolidates an express inadequate consideration network with profound learning and proposes a viable feeling acknowledgment and order strategy for complex music informational collections. In the first place, the strategy utilizes fine-grained division and different techniques to preprocess the example informational collection, to give a high-quality input information test set for the characterization model.

unequivocal scanty consideration network is brought into the profound learning organization to diminish the impact of insignificant data on the acknowledgment results and further develop the feeling characterization and acknowledgment capacity of music test informational collection. Recreation try depends on the genuine informational index of the organization.

The acknowledgment precision of the proposed technique is 0.701 for blissful feelings and 0.688 for miserable feelings. It has a decent capacity of music feeling acknowledgment and characterization. It advances the comparing information preprocessing and works on the nature of the info information of the model, in order to further develop the acknowledgment exactness of the model.

The system provides the unequivocal meager consideration instrument to screen out a couple of data intentionally, which makes the consideration dispersion more engaged and has the capacity of component data obtaining and information investigation contrasted and the correlation strategies. The strategy can precisely dissect and arrange the mind-boggling information.

A “Music Recommendation by Facial Emotion using deep learning” is a work on the precision of music feeling acknowledgment and arrangement, this review consolidates an express inadequate consideration network with profound learning and proposes a viable feeling acknowledgment and order strategy for complex music informational collections.

A strategy utilizes fine-grained division and different techniques to preprocess the example informational collection, to give a high-quality input information test set for the characterization model. 'e unequivocal scanty consideration network is brought into the profound learning organization to diminish the impact of insignificant data on the acknowledgment results and further develop the feeling characterization and acknowledgment capacity of music test informational collection.

A Recreation try depends on the genuine informational index of the organization. Trial results show that the acknowledgment precision of the proposed technique is 0.701 for blissful feelings and 0.688 for miserable feelings.

A decent capacity of music feeling acknowledgment and characterization. It advances the comparing information preprocessing and works on the nature of the info information of the model, in order to further develop the acknowledgment exactness of the model. Proposed technique presents the unequivocal meager consideration instrument to screen out a couple of data intentionally, which makes the consideration dispersion more engaged.

A capacity of component data obtaining and information investigation contrasted and the correlation strategies. Trial results demonstrate the way that the proposed strategy can precisely dissect and arrange the mind-boggling information.

The system “Music Recommendation by Facial Emotion using deep learning” is a work on the precision of music feeling acknowledgment and arrangement, this review consolidates an express inadequate consideration network with profound learning and proposes a viable feeling acknowledgment and order strategy for complex music informational collections. In the first place, the strategy utilizes fine-grained division and different techniques to preprocess the example informational collection, to give a high-quality input information test set for the characterization model. 'e unequivocal scanty consideration network is brought into the profound learning organization to diminish the impact of insignificant data on the acknowledgment results and further develop the feeling characterization and acknowledgment capacity of music test informational collection. Recreation try depends on the genuine informational index of the organization. The acknowledgment precision of the technique is 0.701 for blissful feelings and 0.688 for miserable feelings. It has a decent capacity of music feeling acknowledgment and characterization. It advances the comparing information preprocessing and works on the nature of the info information of the model, in order to further develop the acknowledgment exactness of the model. The system provides the unequivocal meager consideration instrument to screen out a couple of data intentionally, which makes the consideration dispersion more engaged and has the capacity of component data obtaining and information investigation contrasted and the correlation strategies. The strategy can precisely dissect and arrange the mind-boggling information.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A music recommendation system by facial emotion using deep learning, the system comprises:
an input device for collecting sound and sound information or extracting sound information from a music sample;
a pre-processor for pre-processing the informational collection to generate an input information test set for a characterization model, wherein the pre-processor utilizes fine-grained division and different techniques to preprocess the example informational collection;
a central processor for combining the sound feeling data and further developing the arrangement speed, such that review makes fine-grained division for the genuine music informational collection and results the inclination results by casting a ballot direction, which is configured to promote precision of music feeling grouping;
a vocal division device for dividing vocal of the complicated structure of genuine music sound, and the voice and foundation sound are incorporated together; and
a reviewing device for reviewing the vocal detachment of music and reviewing the grouping impact of vocal and foundation sound individually, which incredibly builds the convergence of sound elements, wherein the unequivocal scanty consideration network is brought into the profound learning organization to diminish the impact of insignificant data on the acknowledgment results and further develop the feeling characterization and acknowledgment capacity of music test informational collection.

2. The system as claimed in claim 1, wherein the Fine-Grained Division is configured to optimize the pre-processor to resolve the issues selected from too prolonged stretch of time prompts too enormous element aspect, slow preparation speed, and the classifier being inclined to overfitting.

3. The system as claimed in claim 2, wherein the fine-grained division and different techniques are employed to optimize the time spent highlight extraction even if the music time is excessively lengthy, bringing about too enormous element aspects and complex parts.

4. The system as claimed in claim 1, wherein the current music is put away as advanced music, wherein the genuine popular music is utilized as the wellspring of the informational index.

5. The system as claimed in claim 1, wherein the recreation try depends on the genuine informational index of the organization.

6. The system as claimed in claim 1, wherein the part of component extraction and component determination through the convolution layer and pooling layer in the CNN model, wherein the CNN model results a bunch of serialized highlight vectors, inputs them into the LSTM network as new elements, and adds an unequivocal scanty consideration network for yield.

7. The system as claimed in claim 1, wherein the feeling characterization is selected from calm, happy, sad, energetic and the like.
